(19) United States
(12) Patent Application Publication
(10) Pub. No.: US 2026/0126541 A1
(43) Pub. Date: May 7, 2026

(54) NON-LINE-OF-SIGHT OBJECT DETECTION

(71) Applicant: Ford Global Technologies, LLC, Dearborn, MI (US)

(72) Inventors: Sathyanarayana Chary Palakonda, Northville, MI (US); Ivan Vukovic, Birmingham, MI (US)

(21) Appl. No.: 18/939,029

(22) Filed: Nov. 6, 2024

(51) Int. Cl. G01S 13/46

(52) U.S. Cl. CPC G01S 13/46; G01S 2013/466

(57) ABSTRACT

A position of a mobile device relative to a vehicle is determined. Time-of-flight (TOF) messages exchanged between ultra-wideband (UWB) anchors and a mobile device are detected via UWB anchors of a vehicle. Responsive to a lack of receipt of TOF messages from a quantity of the UWB anchors necessary for performing trilateration for at least a plurality of consecutive ranging rounds, the vehicle switches on a radar mode to detect angle of arrival and distance information between the UWB anchors and the mobile device. Responsive to switching on a radar mode, the vehicles receive channel impulse response (CIR) data from the UWB anchors. A position of the mobile device is determined based on the CIR data and the TOF messages. The position of the mobile device it utilized for one or more vehicle application.

### TECHNICAL FIELD

Aspects of the disclosure generally relate to detecting and handling situations in which an ultra-wideband (UWB) mobile device is not line-of-sight.

### BACKGROUND

Phone trilateration using UWB technology is a method for precise location tracking and positioning. UWB uses very short pulses over a wide frequency spectrum, allowing for accurate distance measurements. In trilateration, the position of a device is determined by calculating the distances from three or more known reference points, typically UWB anchors. The device measures the time it takes for UWB signals to travel between it and each UWB anchor, converting these time-of-flight measurements into distance estimates. By using multiple distance measurements, the exact position of the device can be pinpointed, often within a few centimeters. This method is used in applications such as indoor navigation, asset tracking, and augmented reality.

Channel impulse responses (CIRs) may be used to provide radar functionality, in systems utilizing UWB technology. CIRs may represent a time-domain response of a signal as it travels through a channel, capturing the reflections, diffractions, and scattering of the signal off objects in the environment. By analyzing the CIRs, the presence, distance, and velocity of objects may be identified.

### SUMMARY

In one or more illustrative examples, a method implemented by a controller of a vehicle for determining a position of a mobile device relative to a vehicle, includes detecting, via ultra-wideband (UWB) anchors of a vehicle, time-of-flight (TOF) messages exchanged between the UWB anchors and a mobile device in a ranging mode; responsive to a lack of receipt of TOF messages from a quantity of the UWB anchors necessary for performing trilateration for at least a plurality of consecutive ranging rounds, switching to a radar mode to detect angle of arrival and distance information between the UWB anchors and the mobile device; responsive to switching to the radar mode on one or more of the UWB anchors, receiving channel impulse response (CIR) data from the UWB anchors; determining a position of the mobile device based on the CIR data and the TOF messages; and utilizing the position of the mobile device for one or more vehicle applications.

In one or more illustrative examples, the method further includes calculating angle of arrival (AOA) of signals from the mobile device and the distance information using the CIR data from the UWB anchors and using the AOA information to select radar data from the UWB anchors closest to the UWB anchors providing the TOF messages when determining the position of the mobile device.

In one or more illustrative examples, the method further includes scheduling all of the UWB anchors to perform in the radar mode, the angle of arrival and distance determination.

In one or more illustrative examples, the method further includes scheduling only the UWB anchors for which the TOF messages are received to perform, in the radar mode, the angle of arrival and distance determination.

In one or more illustrative examples, the method further includes scheduling UWB radar sessions in the radar mode and UWB ranging sessions in the ranging mode by configuring specific ones of the UWB anchors to send radar packets without overlapping with other UWB anchors and without interfering with slots reserved for ranging.

In one or more illustrative examples, the method further includes one or more vehicle applications include an application for providing secure access to the vehicle.

In one or more illustrative examples, the method further includes method further includes responsive to the receipt of the TOF messages from the quantity of the UWB anchors necessary for performing the trilateration for at least the plurality of consecutive ranging rounds, switching off the radar mode previously turned on to localize the mobile device.

In one or more illustrative examples, the method further includes comprising one or more of utilizing unused time slots within the ranging rounds for radar sessions in the ranging mode; utilizing unused ranging rounds for the radar sessions; and/or utilizing a combination of unused time slots within an existing ranging round and unused ranging rounds for the radar sessions.

In one or more illustrative examples, the method further includes alternating between UWB radar sessions in the radar mode and UWB ranging sessions in the ranging mode in a time-synchronous manner to perform the trilateration.

In one or more illustrative examples, a system for scheduling UWB radar and ranging sessions includes one or more UWB anchors of a vehicle; and a controller of the vehicle, configured to detect, via the one or more UWB anchors of the vehicle, TOF messages exchanged between the one or more UWB anchors and a mobile device in a ranging mode, responsive to a lack of receipt of TOF messages from a quantity of the UWB anchors necessary for performing trilateration for at least a plurality of consecutive ranging rounds, switching on radar mode to detect angle of arrival information and distance between the UWB anchors and the mobile device, responsive to switching to the radar mode, receive CIR data from the UWB anchors, determine a position of the mobile device based on the CIR data and the TOF messages, and utilize the position of the mobile device for one or more vehicle applications.

In one or more illustrative examples, the one or more UWB anchors is a single UWB anchor, and the position of the mobile device is determined based on the CIR data and using the TOF messages from only the single UWB anchor.

In one or more illustrative examples, the controller is further configured to calculate AOA of signals from the mobile device and the distance using the CIR data from the UWB anchors and using the AOA information to select radar data from the UWB anchors closest to the UWB anchors providing the TOF messages when determining the position of the mobile device.

In one or more illustrative examples, the controller is further configured to schedule all of the UWB anchors to perform, in the radar mode, an angle of arrival and distance determination.

In one or more illustrative examples, the controller is further configured to schedule only the UWB anchors for which the TOF messages are received to perform, in the radar mode, an angle of arrival and distance determination.

In one or more illustrative examples, the controller is further configured to schedule UWB radar sessions in the radar mode and UWB ranging sessions in the ranging mode by configuring specific ones of the UWB anchors to send radar packets without overlapping with other UWB anchors and without interfering with slots reserved for ranging.

In one or more illustrative examples, the one or more vehicle applications include an application for providing secure access to the vehicle.

In one or more illustrative examples, the controller is further configured to one or more of utilize unused time slots within the ranging rounds for radar sessions in the radar mode; utilize unused ranging rounds for the radar sessions; and/or utilize a combination of unused time slots within an existing ranging round and unused ranging rounds for the radar sessions.

In one or more illustrative examples, the controller is further configured to alternate between UWB radar sessions in the radar mode and UWB ranging sessions in the ranging mode in a time-synchronous manner to perform the trilateration.

In one or more illustrative examples, a non-transitory computer-readable medium includes instructions that, when executed by a controller of a vehicle having a plurality of UWB anchors, cause the controller to perform operations including to detect, via UWB anchors of a vehicle, TOF messages exchanged between the UWB anchors and a mobile device; responsive to a lack of receipt of TOF messages from a quantity of the UWB anchors necessary for performing trilateration for at least a plurality of consecutive ranging rounds, switch to a radar mode to detect angle of arrival and distance information between the UWB anchors and the mobile device; responsive to switching to the radar mode, receive CIR data from the UWB anchors; determine a position of the mobile device based on the CIR data and the TOF messages; and utilize the position of the mobile device for one or more vehicle application.

In one or more illustrative examples, the non-transitory computer-readable medium further includes instructions that, when executed by the controller, cause the controller to perform operations including to schedule all of the UWB anchors to perform, in the radar mode, an angle of arrival and distance determination.

In one or more illustrative examples, the non-transitory computer-readable medium further includes instructions that, when executed by the controller, cause the controller to perform operations including to schedule only the UWB anchors for which the TOF messages are received to perform, in the radar mode, an angle of arrival and distance determination.

### BRIEF DESCRIPTION OF THE DRAWINGS

FIG. 1 illustrates an example system including a vehicle implementing UWB radar and ranging for locating mobile devices;

FIG. 2 illustrates further aspects of the controller implementing UWB radar and ranging modes;

FIG. 3A illustrates an example of the scheduling of ranging sessions;

FIG. 3B illustrates an example of the scheduling of radar sessions in unused time slots within an existing ranging round;

FIG. 3C illustrates an example of the scheduling of radar sessions in the unused ranging rounds;

FIG. 3D illustrates an example of the scheduling of radar sessions both in unused time slots within an existing ranging round and also in the unused ranging rounds;

FIG. 3E illustrates an example data flow for the operation of the controller in scheduling ranging rounds and radar rounds;

FIG. 4A illustrates an example of a first use case in which the UWB device is detected in proximity to the vehicle;

FIG. 4B illustrates an example of media access control (MAC) layer scheduling for the first use case;

FIG. 5A illustrates an example of a second use case in which the UWB device of FIG. 4A is instead in an obstructed position;

FIG. 5B illustrates an example of MAC layer scheduling for the second use case;

FIG. 6A illustrates an example of the second use case in which the MAC scheduler schedules radar functionality due to the lack of response for the ranging;

FIG. 6B illustrates an example of the scheduled radar functionality in the ranging rounds for the second use case;

FIG. 7 illustrates an example data flow for the operation of the algorithm for locating mobile devices;

FIG. 8A illustrates an alternate example of the second use case in which the MAC scheduler schedules radar functionality due to the lack of response for the ranging;

FIG. 8B illustrates an alternate example of the scheduled radar functionality in the ranging rounds for the second use case;

FIG. 9 illustrates an example data flow for the operation of the algorithm for locating mobile devices using the alternate example of FIGS. 8A-8B;

FIG. 10 illustrates an example process for implementing UWB radar and ranging; and

FIG. 11 illustrates an example computing device for implementing aspects of UWB radar and ranging.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Some UWB vehicle solutions may operate poorly if UWB devices (e.g., phones, watches, or tags) are obstructed by a human body or otherwise not in line-of-sight. In an example, distances derived from ranging may be significantly incorrect, reducing the ability of the vehicle to perform localization of the user via UWB ranging. This may result in poor application behavior.

Aspects of the disclosure utilize both radar and ranging aspect of the UWB technology to provide seamless service to the applications. When a device is not in line-of-sight, such as when a phone is in a user’s back pocket, all the vehicle UWB anchors may be unable to communicate and participate in a ranging session. In such a situation, distance using CIR messages and angle of arrival information may be considered in the user position estimation. This may be performed using radar mode information from selected UWB anchors. These distances may be taken into account for calculating the user position by trilateration (e.g., including both radar distances and time-of-flight (TOF) exchange distance). This approach may be performed even with a single TOF message exchange occurring with the UWB device. In some cases, even if multiple TOF based ranges are obtained, the trilateration algorithm may not have a solution and in that case the disclosed approach can be utilized. This may occur, for example, if one of the TOF-based estimation is off due to multipath. The disclosed approach avoids multipath effects and thus improves device localization accuracy.

Two proposed approaches are discussed. In one approach, a single device detects distance and angle of arrival information for detecting user position. Distance and AOA may be obtained from the Ranging mode, from the Radar mode, or from a combination of the two modes. If only the range is available from a particular anchor, the second approach explained next may be applied. Alternatively, the second approach may be used to provide the confidence and accuracy of the first approach. In the second approach, additional UWB anchors may be used to provide radar distance information to triangulate and locate the user with improved precision. Further aspects of the disclosure are discussed in detail herein.

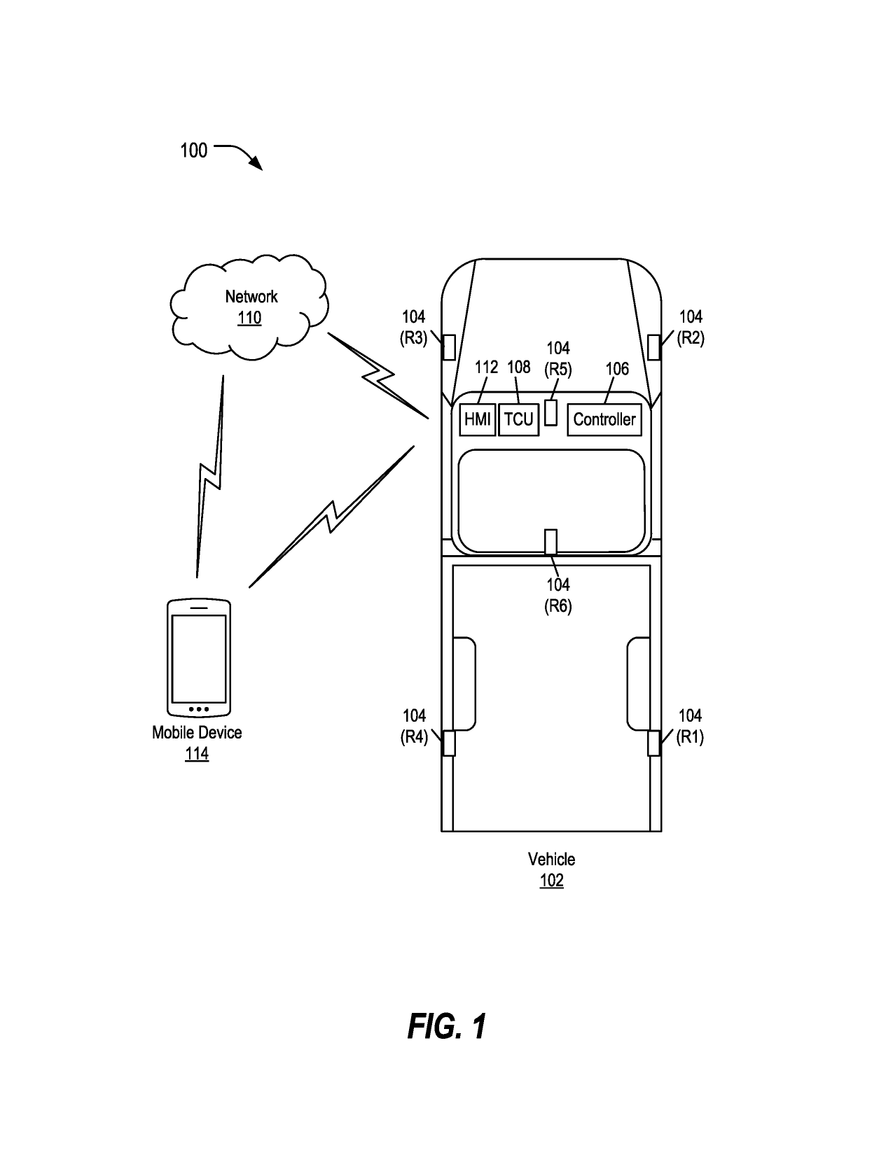

FIG. 1 illustrates an example system 100 including a vehicle 102 implementing UWB radar and ranging. As shown, the vehicle 102 includes a plurality of UWB anchors 104, a controller 106, a telematics control unit (TCU) 108 in communication with a communications network 110, and a human machine interface (HMI) 112. The system 100 may be used to track the position of mobile devices 114 and/or other objects inside and outside of the vehicle 102.

Referring more specifically to FIG. 1, the vehicle 102 may be any passenger or commercial automobile such as a car, a truck, a sport utility vehicle, a crossover, a van, a minivan, a taxi, a bus, etc. The vehicle 102 may include various types of automobile, crossover utility vehicle (CUV), sport utility vehicle (SUV), truck, recreational vehicle, motorcycle, boat, plane or other mobile machine for transporting people or goods. Such vehicles 102 may be human-driven or autonomous. In many cases, the vehicle 102 may be powered by a gasoline, diesel, or hydrogen engine. As another possibility, the vehicle 102 may be a battery electric vehicle (BEV) powered by one or more electric motors. As a further possibility, the vehicle 102 may be a hybrid electric vehicle (HEV) powered by both an engine and one or more electric motors, such as a series hybrid electric vehicle, a parallel hybrid electrical vehicle, or a parallel/series hybrid electric vehicle.

The UWB anchors 104 communicate wirelessly with the mobile device 114 using radio waves. The UWB anchors 104 use an ultra-wideband signal, e.g., a signal with a low energy level spread over a wide frequency channel resulting in very low power spectral density level typically regulated by government agencies. The Federal Communications Commission and the International Telecommunications Union Radiocommunication Sector define ultra-wideband as an antenna transmission for which emitted signal bandwidth exceeds the lesser of 500 MHz or 20% of the arithmetic center frequency. The UWB anchors 104 may use any suitable modulation method, e.g., orthogonal frequency-division multiplexing (OFDM), phase-shift keying (PSK), pulse-position modulation (PPM), etc.

To enable robust user localization, the vehicle 102 may be equipped with UWB responders that are strategically positioned in the interior of the vehicle 102 and within the body structure to provide UWB network coverage of the environment in and around the vehicle 102, i.e., where the mobile device 114 of the user may be located. Depending on the physical design and shape of the vehicle 102, some of the UWB anchors 104 may be placed inside the body walls of the vehicle 102 (e.g., four respectively placed near or/at each corner of the front and rear bumpers of the vehicle 102), center console (e.g., between the driver and passenger seats) and inside the roof (e.g., near the front center, near the rear center).

As shown in the example of FIG. 1, six UWB anchors 104 are shown. These include a first UWB anchor 104 (R1), a second UWB anchor 104 (R2), a third UWB anchor 104 (R3), a fourth UWB anchor 104 (R4), a fifth UWB anchor 104 (R5), and a sixth UWB anchor 104 (R6). The UWB anchors 104 are spaced apart from each other, e.g., spread over the vehicle 102, to increase the ability to distinguish a location when used for trilateration. For example, four of the UWB anchors 104 may be located at respective corners of the vehicle 102 to maximize the horizontal spread of the UWB anchors 104, and the remaining two UWB anchor 104 are located internally to a footprint of the vehicle 102, in many cases at different heights than the corner-mounted UWB anchors 104 to provide a vertical spread. To perform trilateration, computation of the intersection of three or more circles or spheres, may provide the location of the detected device.

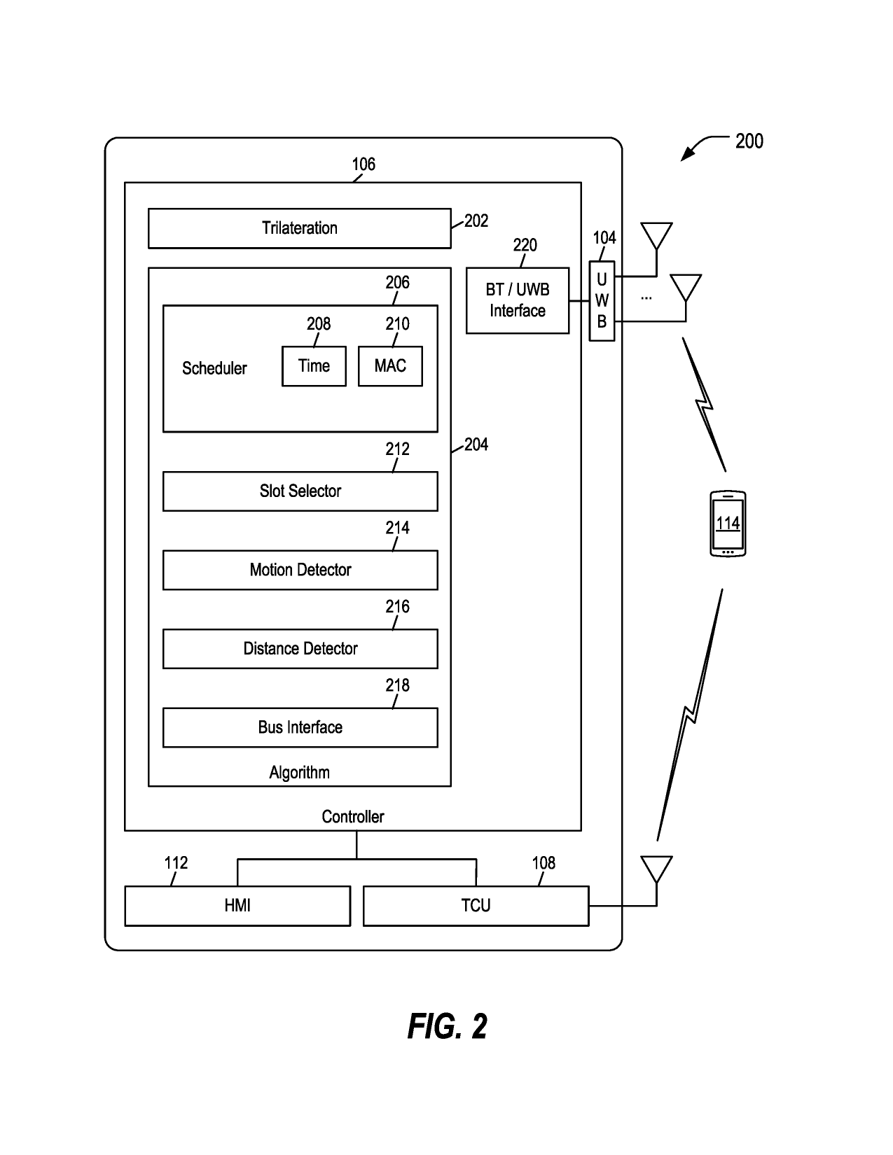

The controller 106 may be a microprocessor-based computing device, e.g., a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. The controller 106 can thus include a processor, a memory, etc. The memory of the controller 106 can include media for storing instructions executable by the processor as well as for electronically storing data and/or databases, and/or the controller 106 can include structures such as the foregoing by which programming is provided. Further details of the controller 106 are discussed with respect to FIG. 2.

The TCU 108 is a controller of the vehicle 102 that may be utilized for communication over a communications network 110. In an example, TCU 108 may be configured to provide telematics services to the vehicle 102. These services may include, as some non-limiting possibilities, navigation, turn-by-turn directions, vehicle health reports, local business search, accident reporting, and hands-free calling. The TCU 108 may include network hardware configured to facilitate communication between the vehicle 102 and other devices of the system 100. For example, the TCU 108 may include or otherwise access a cellular modem configured to facilitate communication with the communications network 110. The communications network 110 may include one or more interconnected communications networks 110 such as the Internet, a cable television distribution network, a satellite link network, a local area network, and a telephone network, as some non-limiting examples. The communications network 110 may provide communications services, such as packet-switched network services (e.g., Internet access, voice over internet protocol (VoIP) communication services), to devices connected to the communications network 110. For instance, the TCU 108 may access the communications network 110 via connection to one or more cellular towers. In another example, the TCU 108 may access the communications network 110 via a Wi-Fi connection.

The HMI 112 may be configured to provide an interface through which the vehicle 102 occupants may interact with the vehicle 102. The interface may include a touchscreen display, voice commands, and physical controls such as buttons and knobs. The HMI 112 may be configured to receive user input via the various buttons or other controls, as well as provide status information to a driver (including information related to the disclosure, such as whether an object has been detected outside the vehicle 102, the locations of mobile devices 114, etc.), such as fuel level information, engine operating temperature information, and current location of the vehicle 102. The HMI 112 may be configured to provide information to various displays within the vehicle 102, such as a center stack touchscreen, a gauge cluster screen, etc. The HMI 112 may accordingly allow the vehicle 102 occupants to access and control various systems such as navigation, entertainment, and climate control.

The mobile devices 114 may include portable computing devices such as smart key fobs; mobile phones, e.g., smartphones; wearable devices, e.g., smartwatches, headsets, etc.; tablets; smart tools, etc. The mobile devices 114 are computing devices including respective processors and respective memories. The mobile devices 114 may be owned and carried by respective persons who may be operators and/or owners of the vehicle 102. In some cases, the mobile devices 114 may be configured to operate as access devices (e.g., phone as a key) to provide access to the vehicle 102.

FIG. 2 illustrates further aspects of the controller 106 implementing UWB radar and ranging modes. As shown, the controller 106 may implement a trilateration algorithm 202 and also a radar ranging algorithm 204. The radar ranging algorithm 204 may include a scheduler 206 configured to utilize time scheduler 208 and MAC scheduler 210, a slot selector 212, a motion detection 214, a distance detector 216, and a bus interface 218. The controller 106 may also include a Bluetooth / UWB interface 220 for communication with the mobile device 114 over Bluetooth and/or UWB. Therefore, the controller 106 may also act as an additional anchor similar to UWB anchors 104. The controller 106 may be in communication through the backend with the UWB anchors 104 and may also be in communication with the TCU 108 and the HMI 112.

Ranging mode in the context of UWB refers to the process of measuring the distance between the UWB devices and an object or another UWB device by calculating the time it takes for a signal to travel to and from the object. This mode relies on the TOF principle, where the time taken by a UWB signal to travel from the transmitter to the receiver is accurately measured, enabling precise calculation of distances. Ranging mode is essential for applications that require accurate location tracking, such as vehicle access systems, where it helps in determining the exact position of the user’s mobile device 114 or key fob relative to the vehicle 102.

Radar mode, on the other hand, involves using UWB technology to detect and track the presence and movement of objects around the vehicle 102. In this mode, UWB anchors 104 emit radar signals that bounce off nearby objects and return to the sensors. By analyzing the returned signals, the system can identify the size, shape, and movement patterns of these objects. For example, channel impulse response (CIR) may be used between the UWB anchors 104 to characterize the wireless environment of the vehicle 102. The CIR may describe how a wireless channel responds to an impulse signal, which is a very short signal, typically a 1-2 nanosecond pulse. The CIR captures the amplitude, phase, and delay of the multipath components that are sent from a transmitter and received by a receiver after reflecting, refracting, or scattering within the environment. By observing the multipath components of the CIR caused by scattering at target objects, movement of objects in and around the vehicle 102 may be detected. Radar mode is particularly useful for enhancing safety by detecting approaching vehicles 102, cyclists, or pedestrians, even when the vehicle 102 is in a low-power state. This mode allows the system to provide real-time alerts and take preventive measures, such as warning the user before opening the door in the path of an oncoming cyclist.

The trilateration algorithm 202 may implement the ranging mode by performing a computation of the intersection of three or more circles or spheres. The UWB anchors 104 may be configured to transmit and receive signals (within signal power thresholds) over UWB channel frequencies (e.g., UWB channel 9 (7.737 – 8.236 GHz) to Channel 5 (6.240 – 6.739 GHz) or other possible channels that are adopted by the UWB standard). Under ideal radio frequency (RF) conditions, e.g., when the mobile device 114 is located within the line of sight (LOS), three UWB anchors 104 may be sufficient in locating the mobile device 114, i.e., the initiator, and thereby enabling trilateration-based localization of the user through responder-to-initiator distance ranging. However, because of the possibility of less favorable RF conditions, data from more than three UWB anchors 104 may be utilized by the controller 106 to ensure there is adequate wireless UWB coverage to locate the mobile device 114.

The radar ranging algorithm 204 is configured to utilize the UWB anchors 104 to implement UWB radar and ranging. The radar ranging algorithm 204 utilizes the scheduler 206 to schedule which of the UWB anchors 104 are to operate in ranging mode and which of the UWB anchors 104 are to operate in radar mode. The scheduler 206 includes a time scheduler 208 that handles timing scheduling based on the position of the object to be tracked. The scheduler 206 also includes a MAC scheduler 210 that selects the ranging slots for radar operation. The radar ranging algorithm 204 utilizes the slot selector 212 to determine which wireless slots to use for radar and which to use for ranging. The motion detection 214 is configured to detect relative changes in position of detected objects over time with reference to the location of the vehicle 102. The distance detector 216 is configured to detect distances of detected objects from the vehicle 102.

The bus interface 218 may be configured to allow the controller 106 to transmit and receive data through a vehicle bus such as a controller area network (CAN) bus, Ethernet, WiFi, Local Interconnect Network (LIN), onboard diagnostics connector (OBD-II), and/or by any other wired or wireless communications network 110. The controller 106 may be communicatively coupled to the UWB anchors 104, the TCU 108, the HMI 112, and/or other components via the communications network 110.

The Bluetooth / UWB interface 220 may be configured to allow the controller 106 to transmit signals wirelessly through the UWB communications that are used by the UWB anchors 104. Also, the Bluetooth / UWB interface 220 may support other protocols, such as cellular, Bluetooth®, BLUETOOTH Low Energy (BLE), WiFi, Institute of Electrical and Electronics Engineer (IEEE) standard 802.11a/b/g/p, cellular-V2X (CV2X), Dedicated Short-Range Communications (DSRC), etc. In other examples, the Bluetooth / UWB interface 220 functionality may be implemented in whole or in part using the TCU 108. In an example, the controller 106 may use the connectivity of the TCU 108 for BLE.

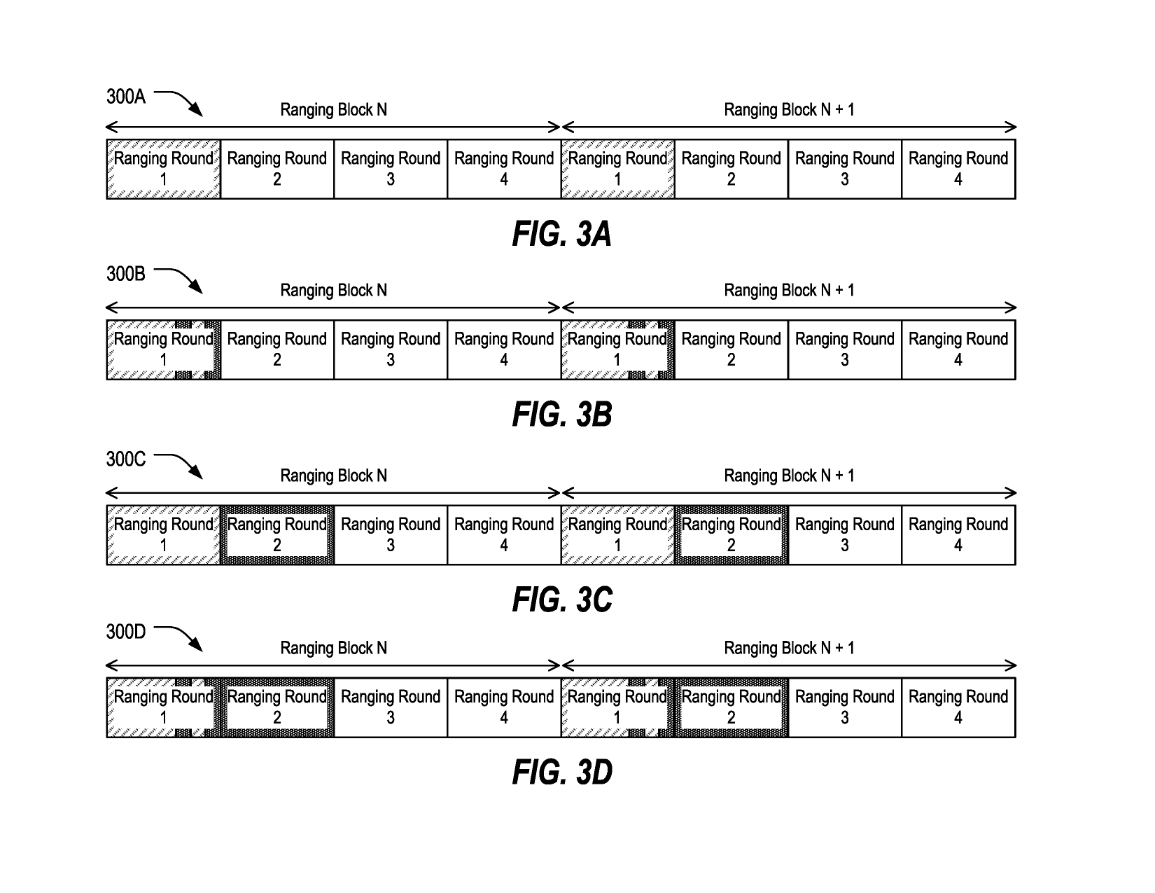

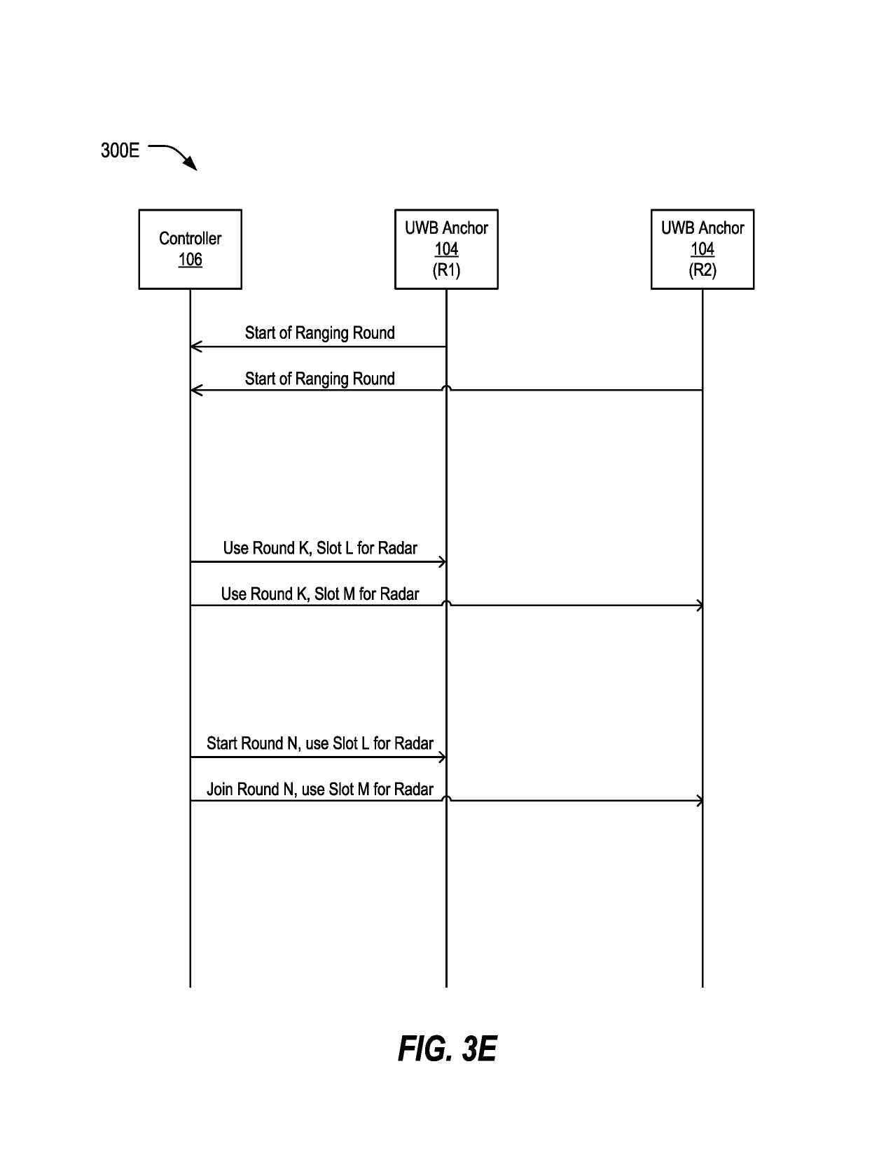

FIGS. 3A-3D collectively illustrate examples of scheduling ranging and radar sessions. FIG. 3A illustrates an example 300A of the scheduling of ranging sessions. FIG. 3B illustrates an example 300B of the scheduling of radar sessions in unused time slots within an existing ranging round. FIG. 3C illustrates an example 300C of the scheduling of radar sessions in the unused ranging rounds. FIG. 3D illustrates an example 300D of the scheduling of radar sessions both in unused time slots within an existing ranging round and also in the unused ranging rounds. Ranging time slots are shown as diagonal hatching, while radar timeslots are shown as dotted hatching.

It should be noted that the decision by the scheduler 206 to leave certain ranging rounds may be based on monitoring of the channel in those rounds and determining that they are used by other UWB anchors 104. Similarly, the controller 106 may be aware of the multiple ranging sessions between UWB anchors 104 and the multiple mobile devices 114 that the user may have (smart phones, key fobs) which organize their sessions independently of each other. In that case the controller 106 may ensure that radar sessions synchronized with a certain mobile device 114 are not overlapping with the ranging and radar sessions synchronized with the another mobile device 114.

Referring more specifically to the example 300A, the connected car consortium (CCC) defines ranging sessions controlled by a device called an initiator, typically a mobile device 114. A handshake between the mobile device 114 and the UWB anchors 104 may occur during a specific ranging round within a time interval called a ranging block, which repeats periodically. As shown, a first ranging block N includes four ranging rounds (1 through 4), and a second ranging block N+1 includes a repeat of those four ranging rounds (1 through 4). The X axis represents time, such that in first ranging block N the first ranking round occurs, then the second, then the third, then the fourth, then the sequence repeats for the next first ranging block N+1. This process may continue indefinitely.

A repeating set of ranging rounds may be used by the controller 106 for performing the ranging. As shown the first ranging round is being used. It should be noted that the ranging rounds that are utilized may hop within the ranging block using a known hopping sequence, while the other non-highlighted ranging rounds are unused by the session.

Referring more specifically to the example 300B, an approach to scheduling radar transmissions is provided by utilizing unused time slots within the already used ranging round. This approach makes efficient use of the time slots available in the ranging block by fitting radar transmissions into the gaps left by the ranging process.

Referring more specifically to the example 300C, another approach to scheduling radar transmissions is provided by utilizing the unused ranging rounds. By dedicating entire ranging rounds to radar transmissions, this approach ensures that there is no interference between the ranging and radar functions, although it might use more overall time in the ranging block.

Referring more specifically to the example 300D, yet another approach combines the above two approaches, using a mix of unused slots in used ranging rounds and completely unused ranging rounds for radar transmissions. This hybrid approach aims to balance efficiency and dedicated time for radar functionality.

FIG. 3E illustrates an example data flow 300E for the operation of the controller 106. As shown, the data flow 300E illustrates the commands being sent from the controller 106 to schedule the UWB anchors 104 (R1 and R2 shown, but other examples would similarly include messaging to additional UWB anchors 104).

The operation labeled Start of Ranging Round indicates the beginning of a new ranging session initiated by the controller 106. This operation is useful for establishing communication between the controller 106 and the UWB anchors 104 (here R1 and R2). During the start of a ranging round, the anchors R1, R2 are synchronized to begin the process of measuring distances by exchanging ranging signals.

Next, the controller 106 indicates, to the anchors R1, R2, the ranging rounds and slots within the rounds that the anchors R1, R2 are scheduled to use for radar. In this operation, the controller 106 instructs the UWB Anchor 104 R1 and UWB Anchor 104 R2 to utilize specific slots (L and M) within a given ranging round (Round K) for radar transmissions. This means that within the time allocated for Round K, slots L and M are reserved for radar pulses. This enables the system to perform radar functions such as detecting moving objects or obstacles while maintaining the ongoing ranging session.

As shown, each of the anchors R1, R2 send a message to the controller 106 indicating the beginning of a ranging round. Next, the controller 106 indicates, to the anchors R1, R2, the ranging rounds and slots within the rounds that the anchors R1, R2 are scheduled to use for radar. Next, the controller 106 directs the anchors R1, R2 to perform the ranging. Here, the anchor R1 is started to perform the round N using the scheduled slot L for radar. Additionally, the anchor R2 is joined to the ranging round, using the scheduled slot M for radar.

Next, at the Start Round N, Use Slot L for Radar operation, this signifies the initiation of a new ranging round (Round N), with Slot L being designated for radar transmissions by UWB Anchor 104 R1. The controller 106 starts this new round to continue the process of monitoring the surroundings, ensuring that the radar pulses are transmitted at the specified time slot to detect objects.

Next, at the Join Round N, Use Slot M for Radar operation, this indicates that the UWB Anchor 104 R2 is joining an already ongoing ranging round (Round N) and is instructed to use Slot M for radar transmissions. This means that R2 synchronizes with the ongoing session and starts transmitting radar pulses in the specified slot. The join operation ensures that R2 can integrate into the ongoing session without disrupting the established communication protocol.

These operations illustrate the coordination between the controller 106 and the UWB anchors 104 (e.g., R1, R2) to ensure seamless integration of ranging and radar functionalities. The scheduler 206 within the controller 106 manages the timing and slot allocation, allowing for efficient use of resources while maintaining continuous monitoring and detection capabilities. The start and join operations are useful for establishing and maintaining synchronization between the controller 106 and the UWB anchors 104, enabling effective communication and radar pulse transmissions.

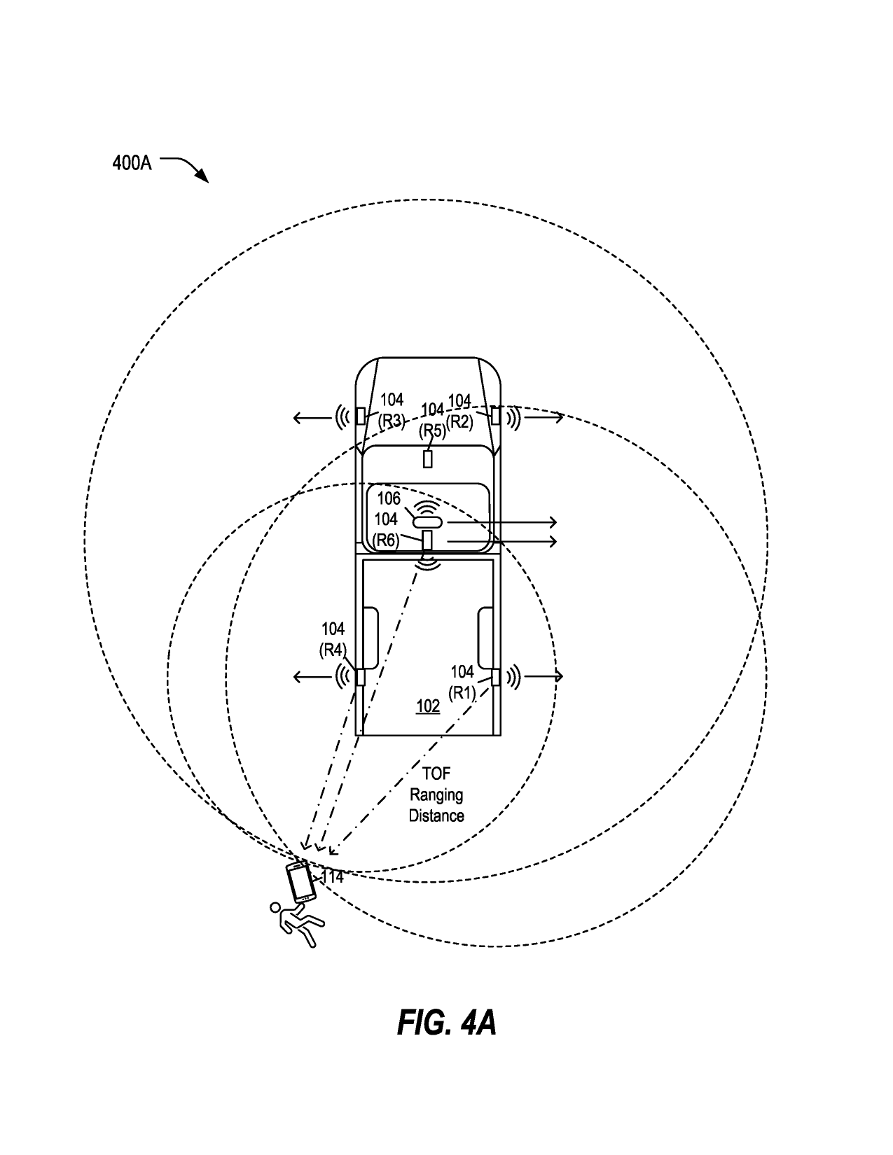

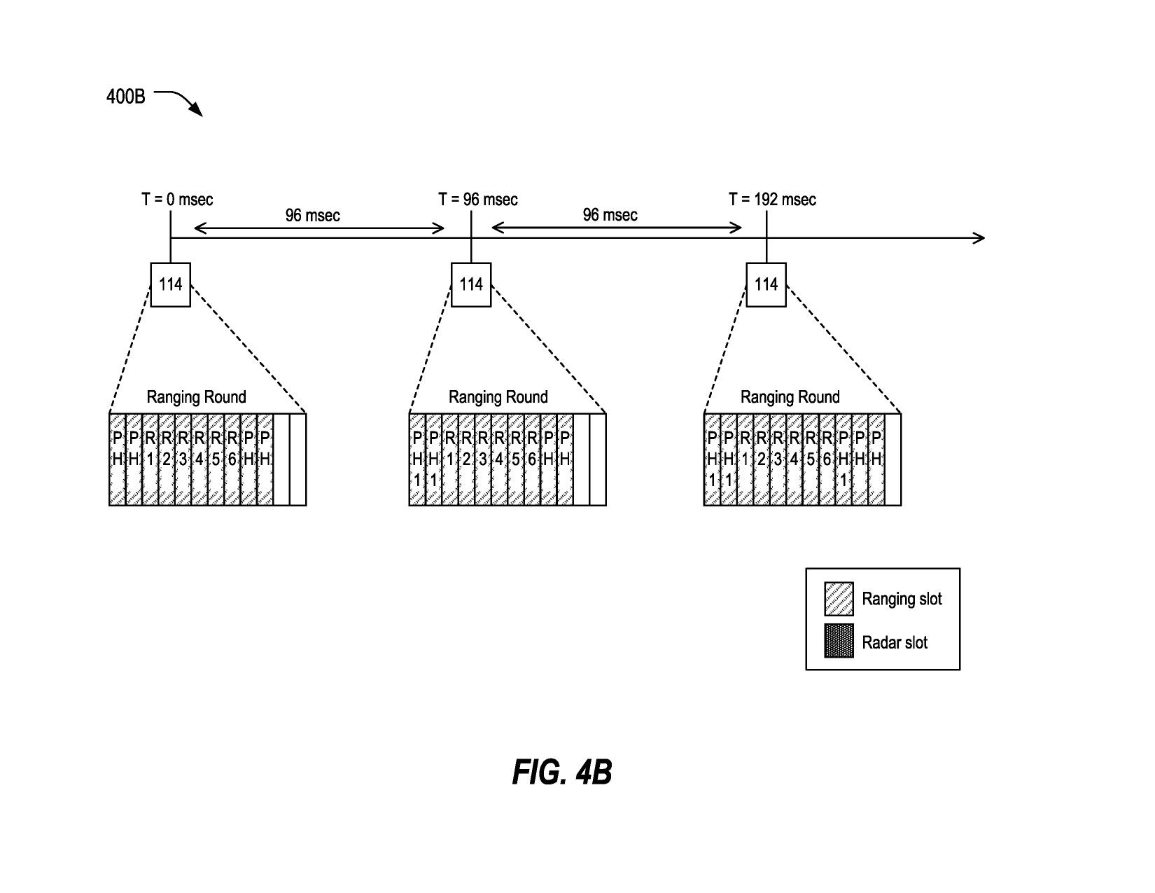

FIG. 4A illustrates an example 400A of a first use case in which the mobile device 114 is detected in proximity to the vehicle 102. As shown, a user holding the mobile device 114 user walks near the vehicle 102.

In this first use case, the vehicle 102 is in a low power mode, and all the UWB anchors 104 in low power ranging mode as per MAC layer scheduling. In this situation, the vehicle 102 exchanges TOF messages in the ranging mode and locates the user using trilateration. In this first use case, the closest UWB anchors 104 (here R1, R4, and R6) exchange TOF messages in a ranging round.

FIG. 4B illustrates an example 400B of MAC layer scheduling for the first use case. As the user moves around the vehicle 102, the vehicle 102 may calculate the user position every 96 msec, as this is one option for the ranging round timing periodicity. A similar situation may be performed if the user places the mobile device 114 in a front pocket facing the vehicle 102, because in such a situation there is minimal obstruction of line of sight and therefore the direct TOF message exchange may occur.

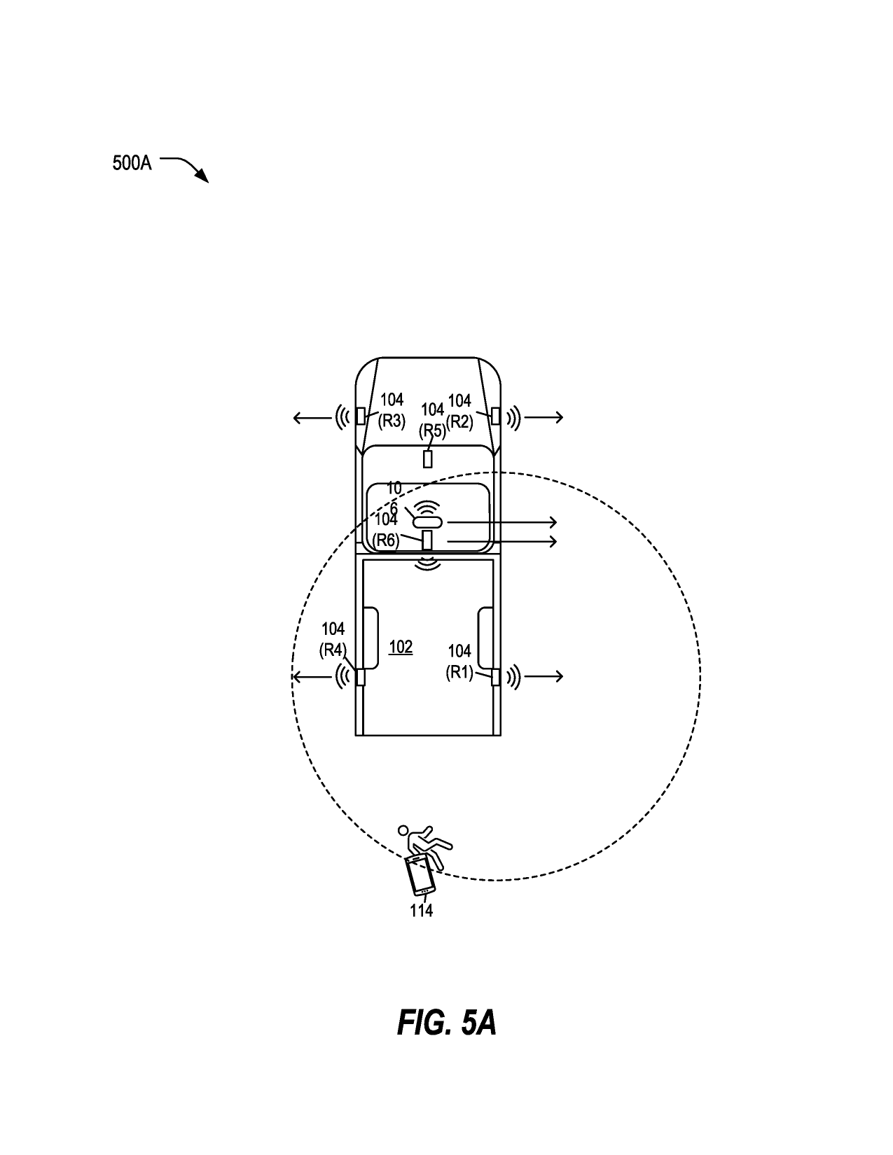

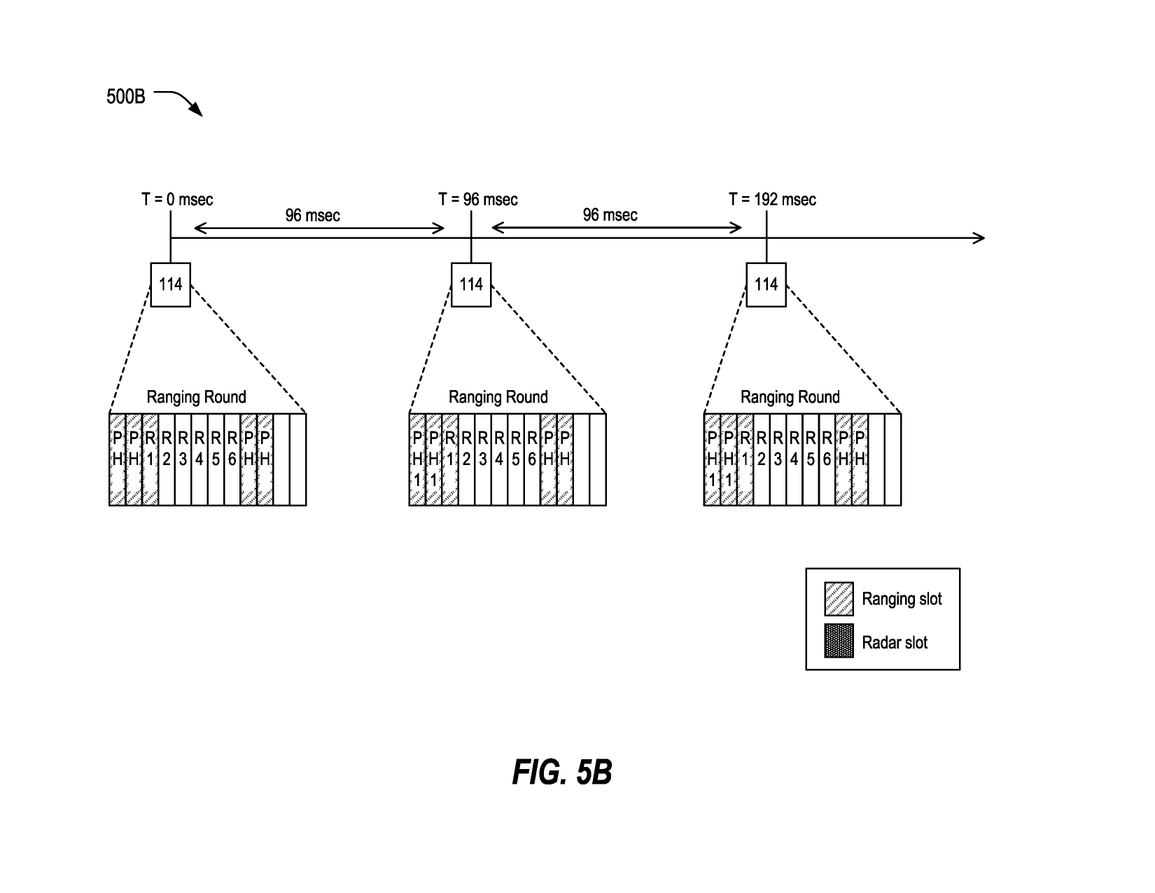

FIG. 5A illustrates an example 500A of a second use case in which the mobile device 114 of FIG. 4A is instead in an obstructed position. In an example, the obstructed position may be in a back pocket such that the user is between the mobile device 114 and the vehicle 102.

In this second use case, the vehicle 102 is again in a low power mode, and all the UWB anchors 104 in low power ranging mode as per MAC layer scheduling. In this situation, the vehicle 102 again exchanges TOF messages in the ranging mode. In this second use case however, only a single UWB anchor 104 (here R1) exchange TOF messages in a ranging round. However, the vehicle 102 is unable to calculate user position with single ranging value.

FIG. 5B illustrates an example 500B of MAC layer scheduling for the second use case. As shown, the R2-R6 UWB anchors 104 receive no response in the ranging rounds.

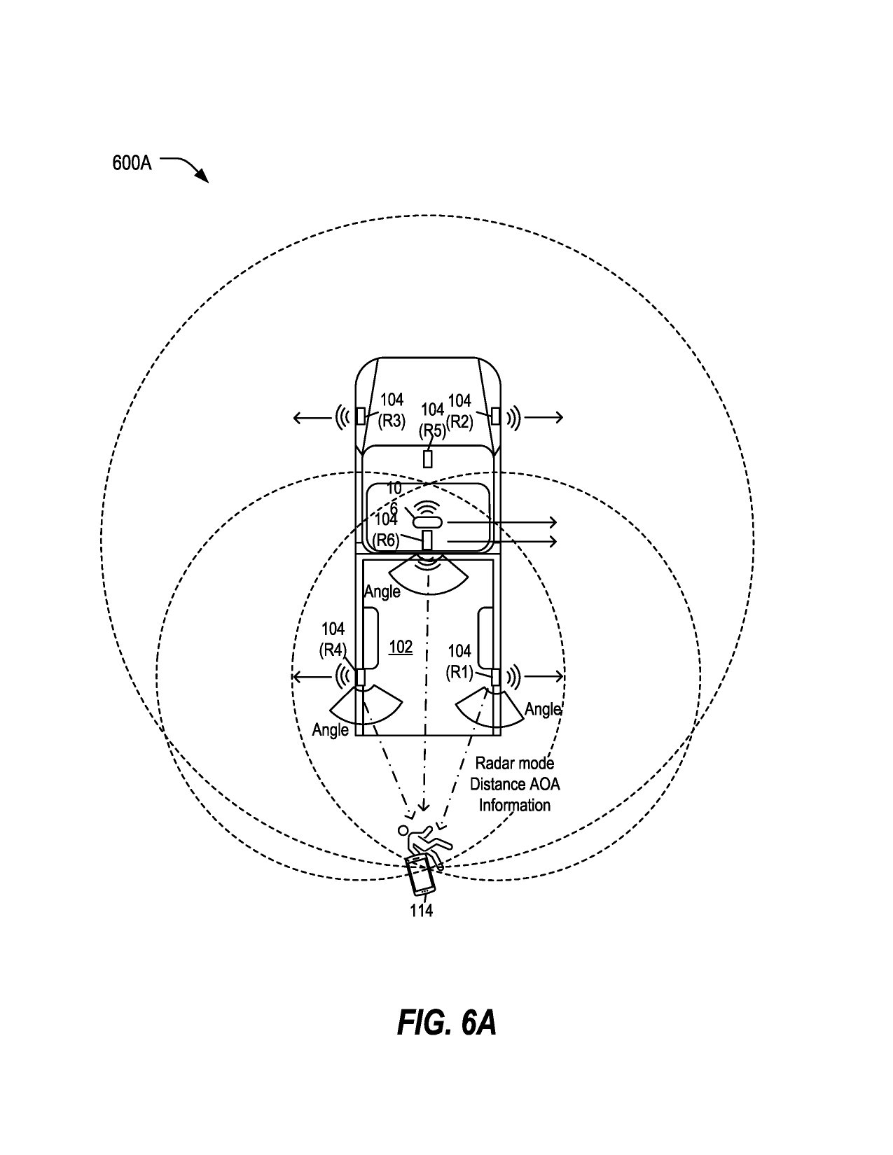

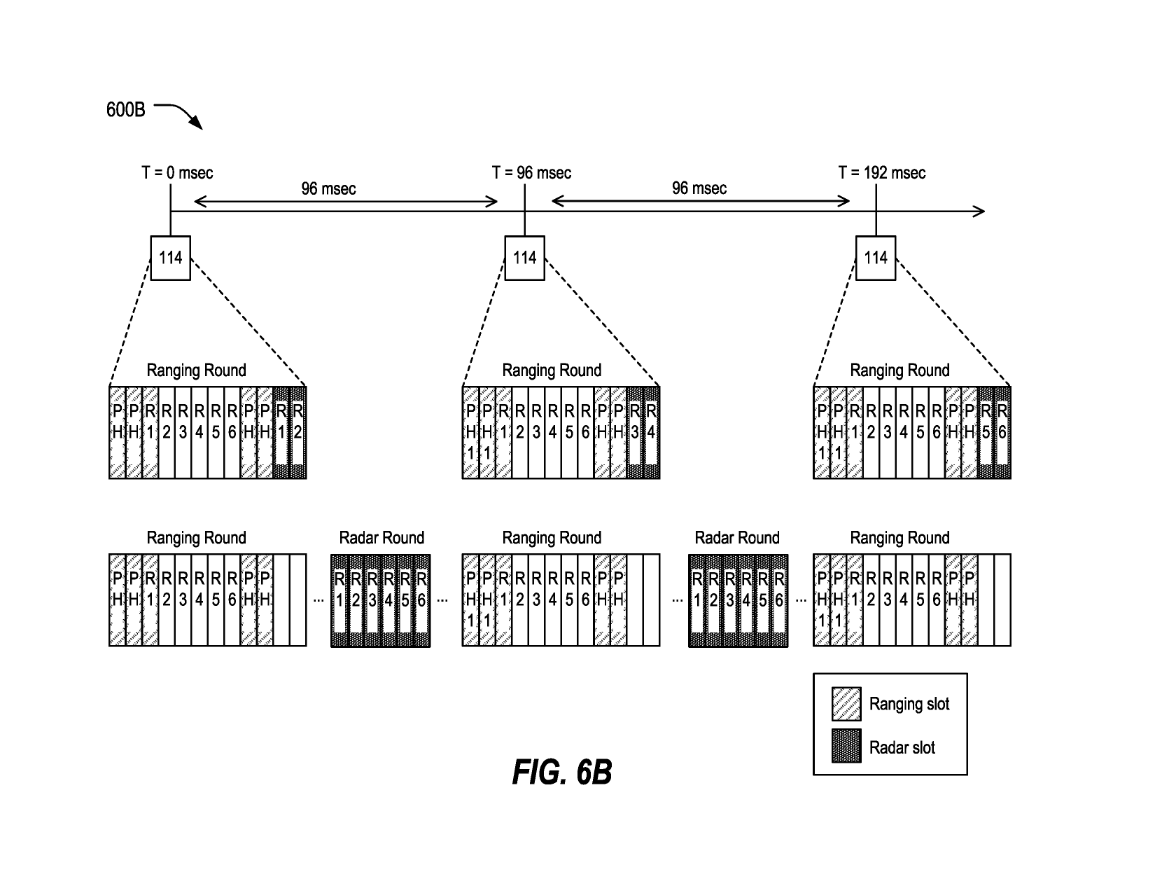

FIG. 6A illustrates an example 600A of the second use case in which the MAC scheduler 210 schedules radar functionality due to the lack of response for the ranging. In an example, if two or more consecutive ranging rounds are missing the TOF ranging value (e.g., less than three ranging distances or however many are required to fix a location of the mobile device 114), the algorithm 204 may utilize the MAC Scheduler 210 to schedule radar functionality in the ranging rounds.

FIG. 6B illustrates an example 600B of the scheduled radar functionality in the ranging rounds for the second use case. As shown, the radar functionality provides 24 msec rounds, with all the UWB anchors 104 switching radar mode on. Using CIR data received in the radar mode, the algorithm 204 may instead determine the distance measurements of the mobile device 114 based on the CIR tab index.

In the FIG. 6B it is assumed that anchor 104 (R1) was the only anchor that received a TOF messages from the mobile device 114 and thus it continues to engage in a ranging session while at the same time utilizing unused slots in the ranging frame for radar transmissions. Since not all the radar transmissions can be accommodated in one ranging round, the anchors 104 take turns in consecutive ranging rounds in a round-robin fashion to transmit radar messages.

It should be understood that this is only one option and that anchors 104 may, in the alternative, schedule the radar transmissions between ranging rounds of this particular mobile device 104 as shown at the bottom of FIG. 6B.

In yet another alternative, not shown, the algorithm may sequentially turn on the radar mode on the anchors 104 which did not report TOF in order to determine which combination may help in trilateration of the mobile device. For example, the algorithm may just turn on the radar mode on anchor R1 and use this information to turn on radar mode on other anchors.

The algorithm 204 may also select the UWB anchor 104 as it receives TOF from one mobile device 114 (in this case received from the R1 UWB anchor 104) to use the angle of arrival information from the radar data to be considered in the distance measurement (here the angles are captured from the R4 and R6 UWB anchors 104 as the user angle is in that direction). The radar mode may perform the process in 96msec such that the algorithm 204 is able to measure the distance from R4 and R6 using the radar mode and from R1 using the ranging mode. As a result, with three distances the location of the mobile device 114 may be updated (here every 96msec). These operations may be repeated if the algorithm 204 is unable to receive at least three TOF results from three different UWB anchors 104 during a ranging round.

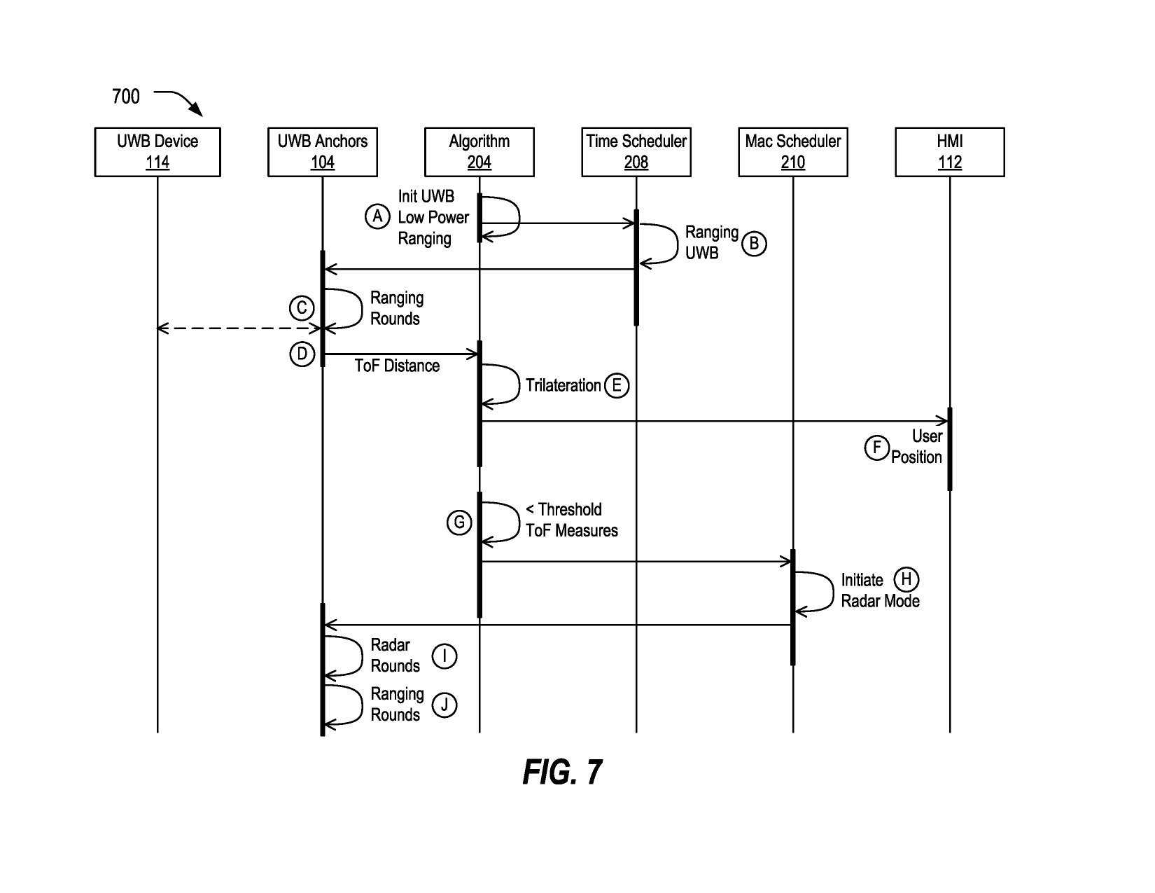

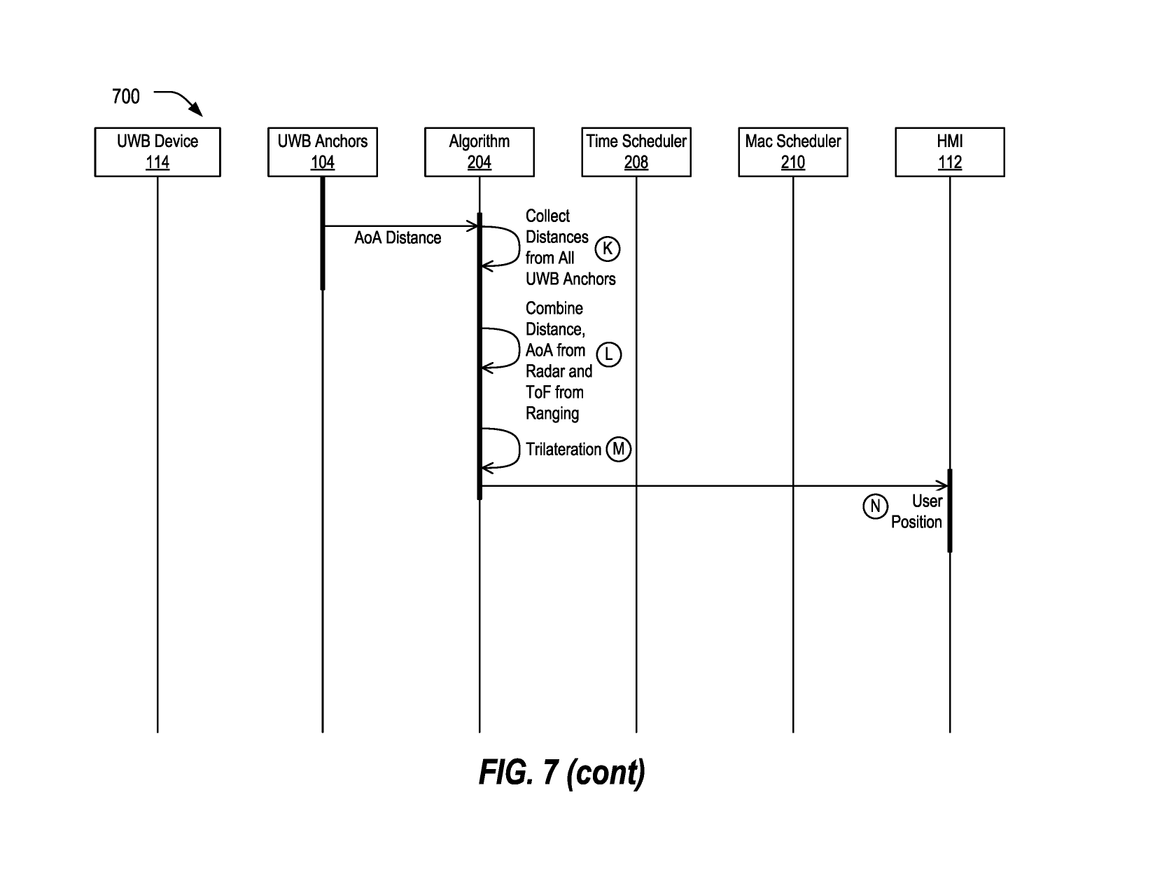

FIG. 7 illustrates an example data flow 700 for the operation of the algorithm 204. In an example, the data flow 700 may be performed by the components of the system 100 discussed in detail herein.

At index (A), the algorithm 204 initializes UWB low power ranging. This may be done, for example, responsive to the vehicle 102 being parked or stopped. To initiate ranging, the algorithm 204 may direct the time scheduler 208 to command the UWB anchors 104 to begin ranging rounds, as shown at index (B). The ranging rounds may be performed at an interval of 96 msec, for example.

At index (C), the UWB anchors 104 perform ranging rounds. At index (D), the UWB anchors 104 sends information indicative of the TOF distance measured between at least a subset of the UWB anchors 104 and the mobile device 114 to the controller 106 to be processed by the algorithm 204.

At index (E), the algorithm 204 performs trilateration using the TOF distances. The trilateration may be performed to locate the mobile device 114, either inside or outside the vehicle 102. The determined user position may be provided, at index (F), to the HMI 112 of the vehicle 102 and/or to one or more applications of the vehicle 102 (or mobile device 114) that depend on the location of the mobile device 114. These may include access control applications, applications that provide lighting to the area surrounding the mobile device 114, etc.

In some instances, ranging distances may not be available to the algorithm 204 from at least a minimum quantity of the UWB anchors 104 (e.g., a minimum of three such that trilateration may be performed). Alternatively, the ranging distances that are available may contain inaccuracies which result in algorithm 204 not being able to find a solution. If as shown at index (G), this occurs for at least a threshold number of consecutive ranking rounds, then the algorithm 204 may elect to switch the radar mode on. As a result, at index (H) the algorithm 204 may direct the Mac scheduler 210 to initiate radar mode. The Mac scheduler 210 may schedule the radar rounds to be performed, for example every 24 msec. It should be understood that it also possible and often preferred to keep the ranging active while the radar mode has been turned on.

At index (I) the radar rounds are performed. At index (J) the ranging rounds (if any) are performed. As shown at index (K), the algorithm 204 collects angle of arrival information from the UWB anchors 104 determined using the radar round. At index (L), the algorithm 204 combines the angle of arrival (AOA) information and the TOF information to determine, at index (M), a trilateration of the mobile device 114. At index (N), as with index (F), the determined user position may be provided to the HMI 112 of the vehicle 102 and/or to one or more applications of the vehicle 102 (or mobile device 114) that depend on the location of the mobile device 114.

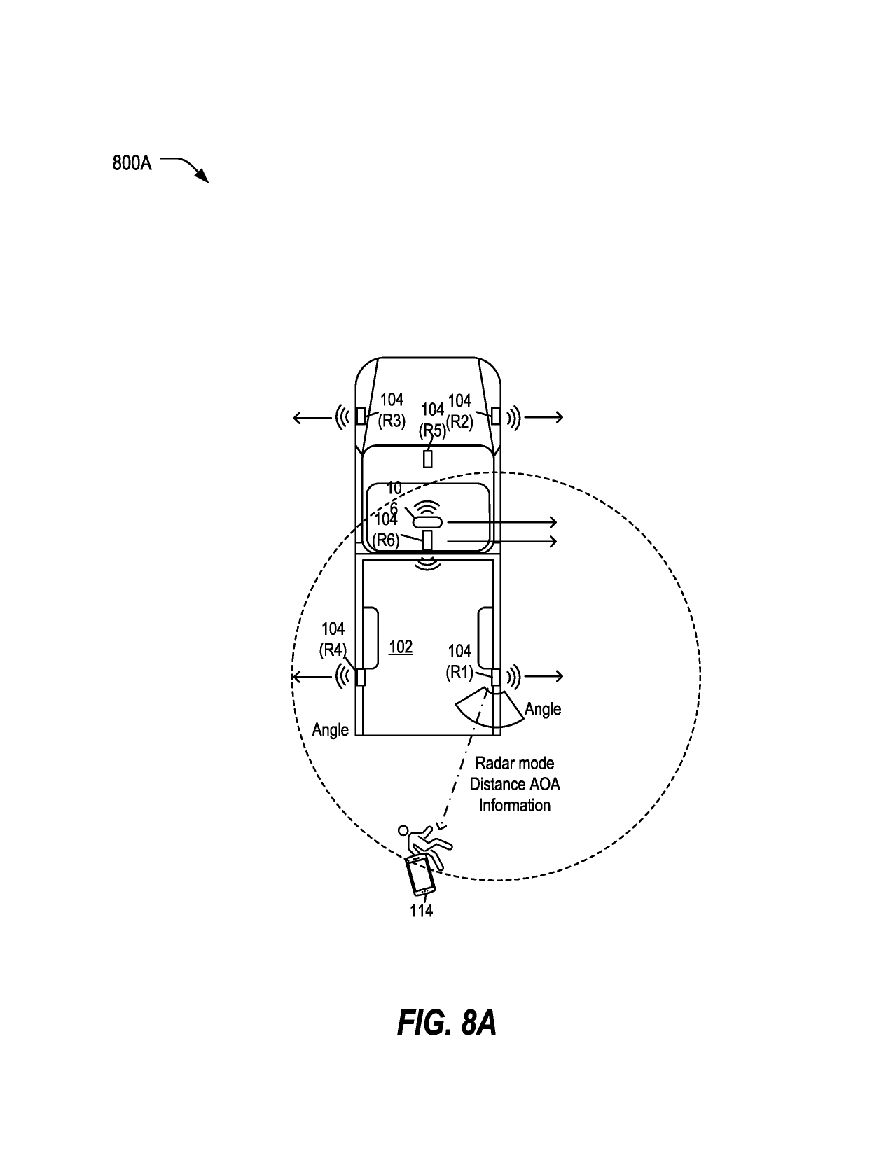

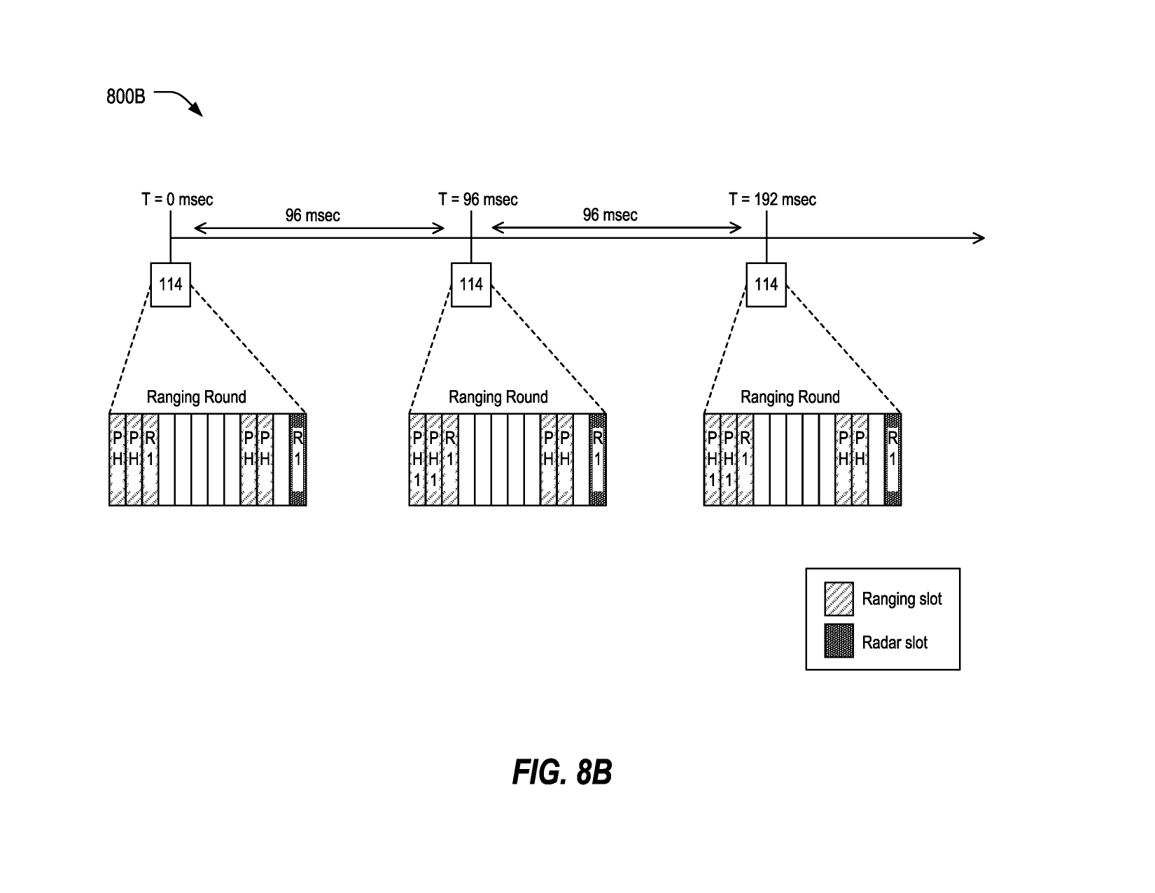

FIG. 8A illustrates an alternate example 800A of the second use case in which the MAC scheduler 210 schedules radar functionality due to the lack of response from the ranging. As discussed with respect to the example 600A, if two or more consecutive ranging rounds are missing the TOF ranging value (e.g., less than three ranging distances or however many are required to fix a location of the mobile device 114), the algorithm 204 may utilize the MAC scheduler 210 to schedule radar functionality in the ranging rounds or outside the ranging rounds in separate radar rounds.

FIG. 8B illustrates an alternate example 800B of the scheduled radar functionality in the ranging rounds for the second use case. As shown, the radar functionality provides 24 msec rounds, with just the UWB anchors 104 that provided TOF information in the radar mode. Using CIR data received in the radar mode, the algorithm 204 may instead determine the distance measurements of the mobile device 114 based on the CIR tab index. In this example, this includes TOF and radar AOA and distance information from the single R1 UWB anchor 104. It should be pointed out that the TOF distance obtained from ranging and the distance obtained from radar-based CIR data should be very close in terms of distance value. The TOF estimates the distance between the anchor 104 and the mobile device 114 while the CIR-based distance is estimated from the reflection of the radar signal from the user body. Since the mobile device 114 should be on the on the user’s body, these two distances should be very close and could be a validity check when performing single device measurements.

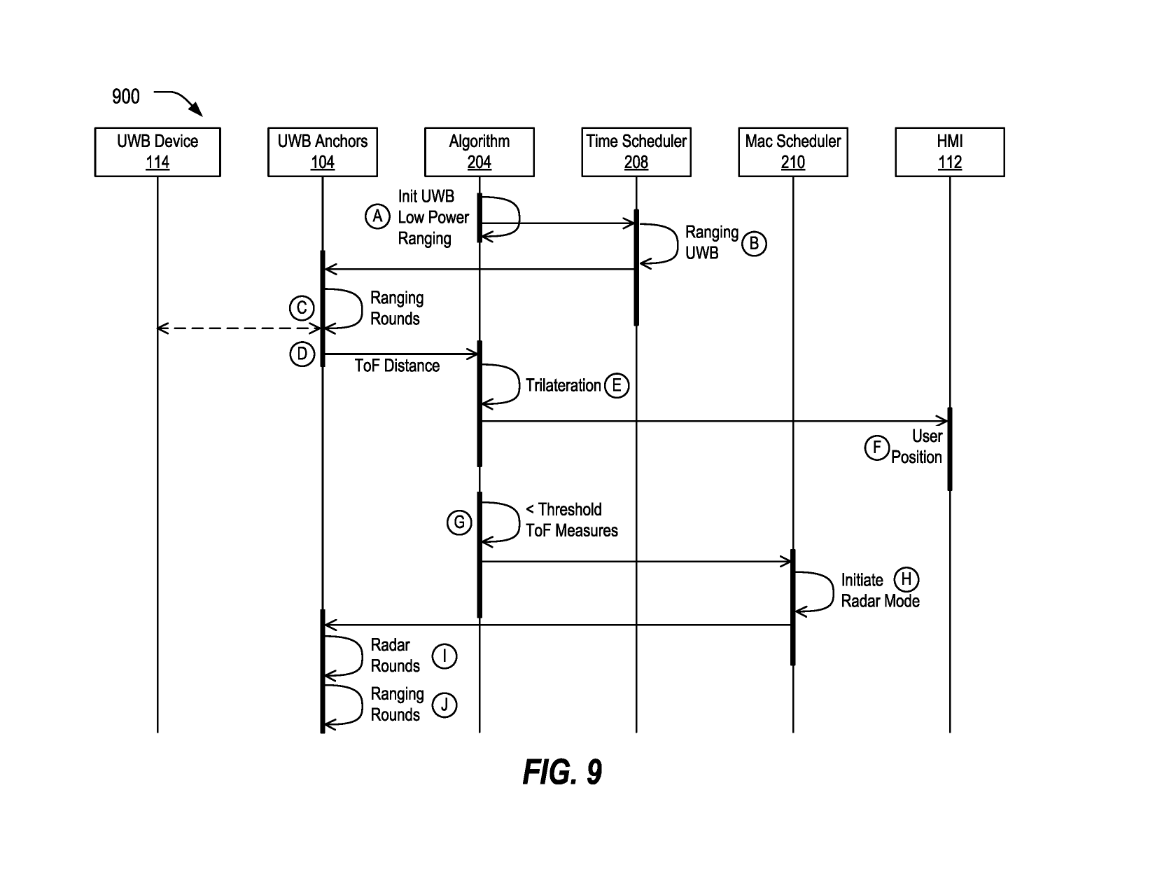

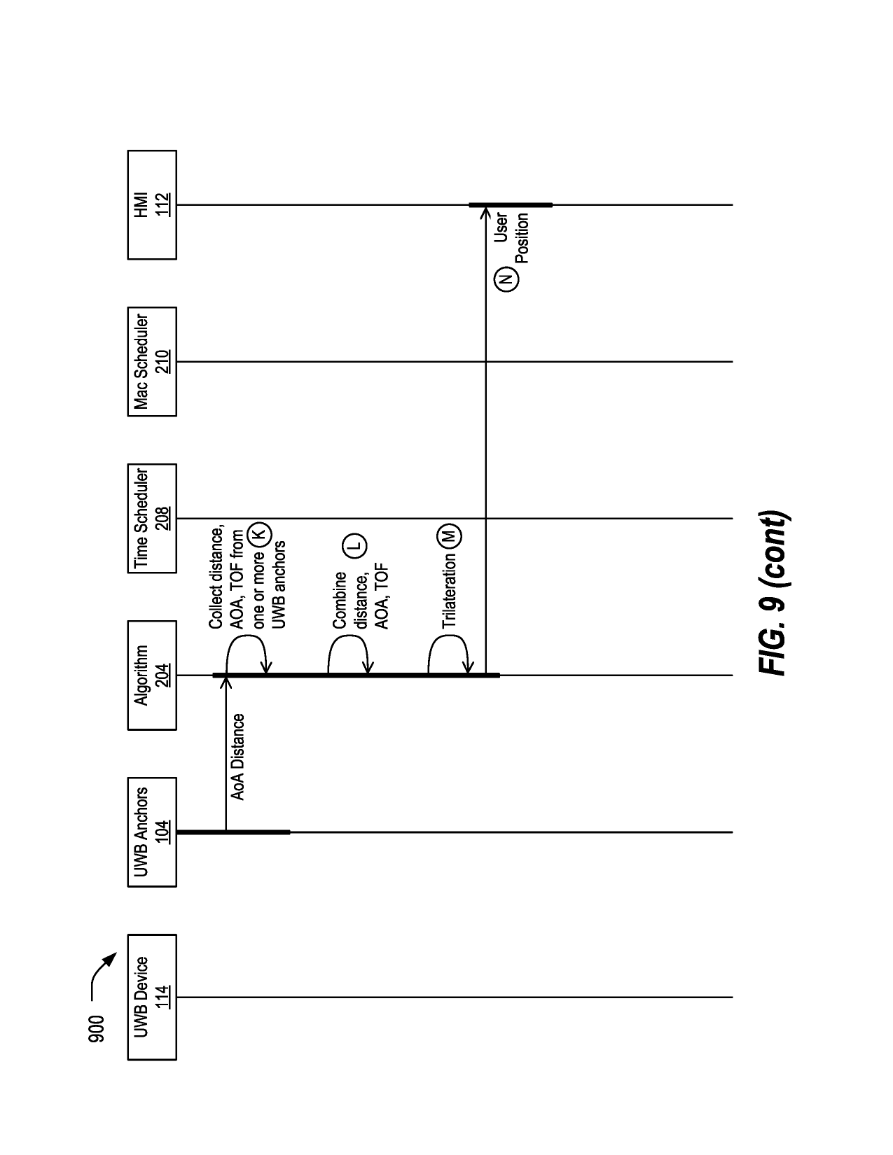

FIG. 9 illustrates an example data flow 900 for the operation of the algorithm 204 using the alternate example of FIGS. 8A-8B. As with the data flow 700, in an example the data flow 900 may be performed by the components of the system 100 discussed in detail herein. The data flow 900 is similar to the data flow 700, except at index (I) the radar rounds only include the set of one or more UWB anchors 104 for which TOF information of the mobile device 114 is captured. Also, the data flow 900 differs in that at indexes (I)-(K) AOA distances are captured only from the set of one or more UWB anchors 104, and at indexes (L)-(M) the distances are combined and location is performed only using the set of one or more UWB anchors 104.

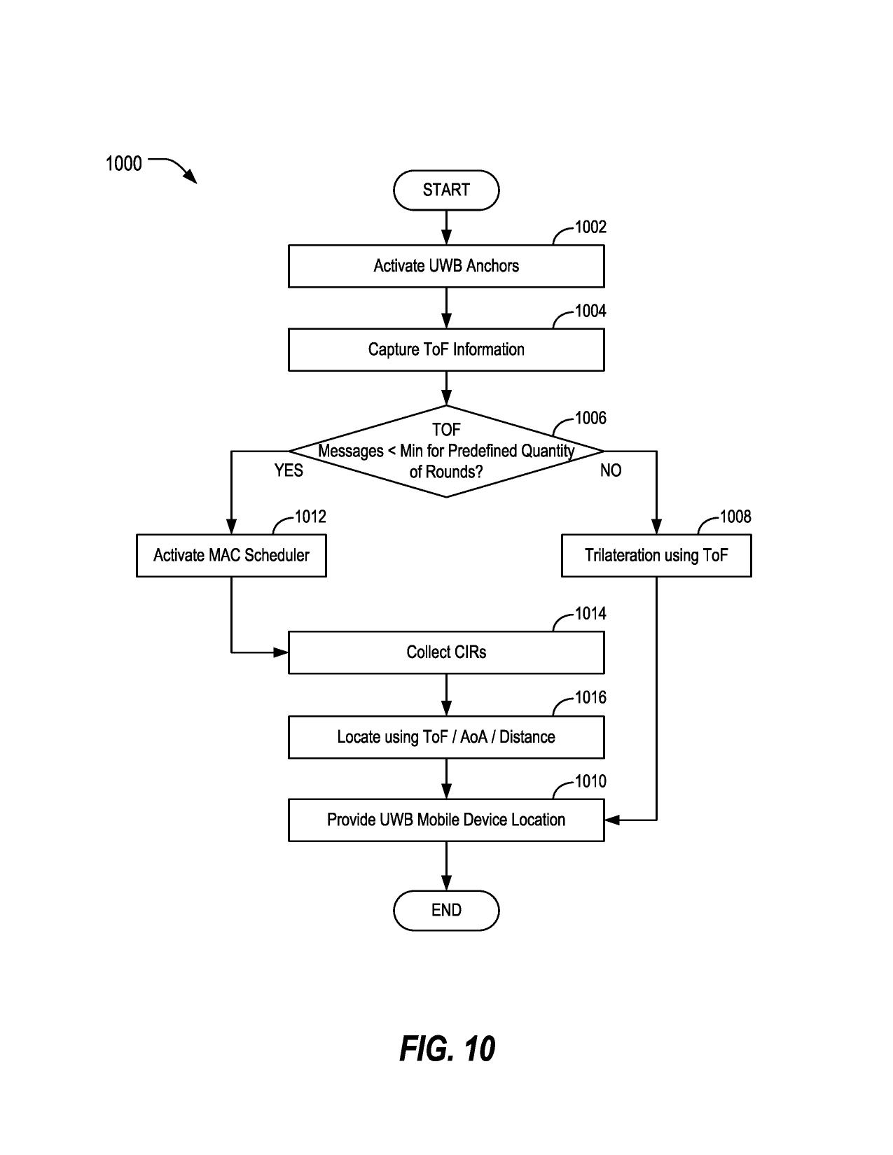

FIG. 10 illustrates an example process 1000 for the operation of the algorithm 204 in locating the mobile device 114. In an example the process 1000 may be performed by the controller 106 in the context of the vehicle 102 and system 100 of FIG. 1.

At operation 1002, the controller 106 activates the UWB anchors 104 to initiate monitoring of the location of the mobile devices 114. This may occur, for example, when the vehicle 102 is turned off, approached, or otherwise activated into a low power mode. Thus, initially the vehicle 102 may turn on the UWB anchors 104 and the controller 106 will be running in a low power mode.

At operation 1004, the controller 106 captures TOF information from the UWB anchors 104. For example, the user may walk around the vehicle 102 in an orientation where the user’s mobile device 114 is in communication with the UWB anchors 104 and able to exchange TOF messages as explained in FIGS. 4A-4B without interference in ranging rounds. Or, the user may be walking in an orientation where the user’s mobile device 114 is unable to exchange TOF messages as explained in FIGS. 5A-5B, 6A-6B, and FIGS. 8A-8B.

At operation 1006, the controller 106 determines whether there has been a lack of TOF messages from a quantity of the UWB anchors 104 necessary for performing trilateration for at least a plurality of consecutive ranging rounds. In an example, the minimum quantity of UWB anchors 104 may be three. In an example, the plurality of consecutive ranging rounds may be more than two. If there are adequate TOF messages to perform trilateration, control proceeds to operation 1008.

At operation 1008, the controller 106 uses the UWB anchors 104 to performs trilateration to determine the positions of devices within the vehicle 102. In trilateration, the position of a mobile device 114 may be determined by calculating distances from three or more of the UWB anchors 104. The controller 106 may measure the time it takes for UWB signals to travel between the mobile device 114 and the UWB anchors 104, converting these time-of-flight measurements into distance estimates. By using multiple distance measurements, the position of the mobile device 114 may be pinpointed. In this portion of the process 1000 the radar mode of operation is not used. After operation 1008, the process 1000 continues to operation 1010.

At operation 1010, the location of the mobile device 114 is provided. The determined user position may be provided, in an example, to the HMI 112 of the vehicle 102. In another example, the determined position may additionally or alternatively be provided to one or more applications of the vehicle 102 (or mobile device 114) that depend on the location of the mobile device 114. These may include access control applications, applications that provide lighting to the area surrounding the mobile device 114, etc. After operation 1010, the process 1000 ends.

At operation 1012, continuing from operation 1006 responsive to the condition that there are not adequate TOF messages for at least the plurality of consecutive ranging rounds, the MAC scheduler 210 is activated to incorporate radar ranging. In an example, this may include scheduling all the UWB anchors 104 to perform the radar mode angle of arrival determination, as shown in FIGS. 6A-6B and 7. In an example, this may include only the UWB anchors 104 for which TOF messages are received to perform the radar mode angle of arrival determination, as shown in FIGS. 8A-8B and 9.

At operation 1014, the controller 106 collects CIRs from the anchors 104 operating in radar mode as well as TOF from the anchors 104 operating successfully in the ranging mode. This may include, for example, calculating the AOA of signals from the mobile device 114 using the CIR data from the UWB anchors 104 and using the AOA information to select radar data from the UWB anchors 104 closest to the UWB anchor 104 providing the TOF information when determining the position of the mobile device 114.

At operation 1016, the controller 106 performs localization using the TOF information from ranging and AOA and distance information from radar mode. Trilateration may be performed if the controller 106 has received TOF information from more than three UWB anchors 104, and in that case radar mode does not need to be turned on. If not, then the AOA and distance obtained from specially selected anchors 104 in radar mode may additionally be incorporated into the determination of the location of the mobile device 114. This allows for the location of the UWB mobile device 114 to be determined, despite a lack of availability of sufficient TOF data from the UWB anchors 104. After operation 1014, the process control to operation 1010 to provide the location.

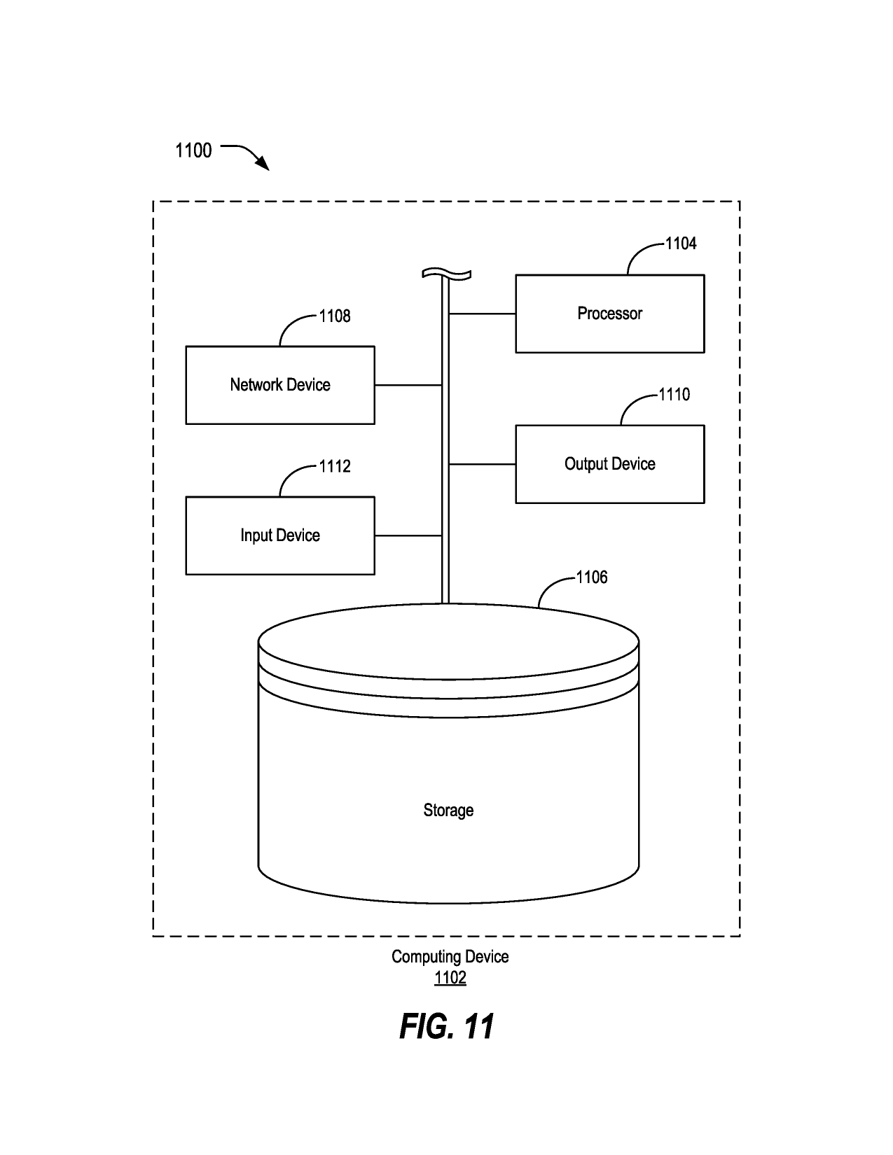

FIG. 11 illustrates an example computing device 1102 for implementing aspects of UWB radar and ranging. Referring to FIG. 11, and with reference to FIGS. 1-10, the vehicle 102, UWB anchors 104, controller 106, TCU 108, communications network 110, HMI 112, and mobile device 114 may include examples of such computing devices 1102. Computing devices 1102 generally include computer-executable instructions, where the instructions may be executable by one or more computing devices 1102. Computer-executable instructions may be compiled or interpreted from computer programs created using a variety of programming languages and/or technologies, including, without limitation, and either alone or in combination, Java™, C, C++, C#, Visual Basic, Python, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

As shown, the computing device 1102 may include a processor 1104 that is operatively connected to a storage 1106, a network device 1108, an output device 1110, and an input device 1112. It should be noted that this is merely an example, and computing devices 1102 with more, fewer, or different components may be used.

The processor 1104 may include one or more integrated circuits that implement the functionality of a central processing unit (CPU) and/or graphics processing unit (GPU). In some examples, the processors 1104 are a system on a chip (SoC) that integrates the functionality of the CPU and GPU. The SoC may optionally include other components such as, for example, the storage 1106 and the network device 1108 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 1104 executes stored program instructions that are retrieved from the storage 1106. The stored program instructions, accordingly, include software that controls the operation of the processors 1104 to perform the operations described herein. The storage 1106 may include both non-volatile memory and volatile memory devices. The non-volatile memory includes solid-state memories, such as Not AND (NAND) flash memory, magnetic and optical storage media, or any other suitable data storage device that retains data when the system is deactivated or loses electrical power. The volatile memory includes static and dynamic random access memory (RAM) that stores program instructions and data during operation of the system 100.

The GPU may include hardware and software for display of at least two-dimensional (2D) and optionally three-dimensional (3D) graphics to the output device 1110. The output device 1110 may include a graphical or visual display device, such as an electronic display screen, projector, printer, or any other suitable device that reproduces a graphical display. As another example, the output device 1110 may include an audio device, such as a loudspeaker or headphone. As yet a further example, the output device 1110 may include a tactile device, such as a mechanically raiseable device that may, in an example, be configured to display braille or another physical output that may be touched to provide information to a user.

The input device 1112 may include any of various devices that enable the computing device 1102 to receive control input from users. Examples of suitable input devices 1112 that receive human interface inputs may include keyboards, mice, trackballs, touchscreens, microphones, graphics tablets, and the like.

The network devices 1108 may each include any of various devices that enable the described components to send and/or receive data from external devices over networks. Examples of suitable network devices 1108 include an Ethernet interface, a Wi-Fi transceiver, a cellular transceiver, or a BLUETOOTH or BLE transceiver, or other network adapter or peripheral interconnection device that receives data from another computer or external data storage device, which can be useful for receiving large sets of data in an efficient manner.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as "a," "the," "said," etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A method implemented by a controller of a vehicle for determining a position of a mobile device relative to a vehicle, comprising:
detecting, via ultra-wideband (UWB) anchors of a vehicle, time-of-flight (TOF) messages exchanged between the UWB anchors and a mobile device in a ranging mode;
responsive to a lack of receipt of TOF messages from a quantity of the UWB anchors necessary for performing trilateration for at least a plurality of consecutive ranging rounds, switching to a radar mode to detect angle of arrival and distance information between the UWB anchors and the mobile device;
responsive to switching to the radar mode on one or more of the UWB anchors, receiving channel impulse response (CIR) data from the UWB anchors;
determining a position of the mobile device based on the CIR data and the TOF messages; and
utilizing the position of the mobile device for one or more vehicle applications.

2. The method of claim 1, further comprising calculating angle of arrival (AOA) of signals from the mobile device and the distance information using the CIR data from the UWB anchors and using the AOA information to select radar data from the UWB anchors closest to the UWB anchors providing the TOF messages when determining the position of the mobile device.

3. The method of claim 1, further comprising scheduling all of the UWB anchors to perform in the radar mode, the angle of arrival and distance determination.

4. The method of claim 1, further comprising scheduling only the UWB anchors for which the TOF messages are received to perform, in the radar mode, the angle of arrival and distance determination.

5. The method of claim 1, further comprising scheduling UWB radar sessions in the radar mode and UWB ranging sessions in the ranging mode by configuring specific ones of the UWB anchors to send radar packets without overlapping with other UWB anchors and without interfering with slots reserved for ranging.

6. The method of claim 1, wherein the one or more vehicle applications include an application for providing secure access to the vehicle.

7. The method of claim 1, further comprising responsive to the receipt of the TOF messages from the quantity of the UWB anchors necessary for performing the trilateration for at least the plurality of consecutive ranging rounds, switching off the radar mode previously turned on to localize the mobile device.

8. The method of claim 1, further comprising one or more of:
utilizing unused time slots within the ranging rounds for radar sessions in the ranging mode;
utilizing unused ranging rounds for the radar sessions; and/or
utilizing a combination of unused time slots within an existing ranging round and unused ranging rounds for the radar sessions.

9. The method of claim 1, further comprising alternating between UWB radar sessions in the radar mode and UWB ranging sessions in the ranging mode in a time-synchronous manner to perform the trilateration.

10. A system for scheduling UWB radar and ranging sessions, the system comprising:
one or more UWB anchors of a vehicle; and
a controller of the vehicle, configured to:
detect, via the one or more UWB anchors of the vehicle, TOF messages exchanged between the one or more UWB anchors and a mobile device in a ranging mode,
responsive to a lack of receipt of TOF messages from a quantity of the UWB anchors necessary for performing trilateration for at least a plurality of consecutive ranging rounds, switching on radar mode to detect angle of arrival information and distance between the UWB anchors and the mobile device,
responsive to switching to the radar mode, receive CIR data from the UWB anchors,
determine a position of the mobile device based on the CIR data and the TOF messages, and
utilize the position of the mobile device for one or more vehicle applications.

11. The system of claim 10, wherein the one or more UWB anchors is a single UWB anchor, and the position of the mobile device is determined based on the CIR data and using the TOF messages from only the single UWB anchor.

12. The system of claim 10, wherein the controller is further configured to calculate AOA of signals from the mobile device and the distance using the CIR data from the UWB anchors and using the AOA information to select radar data from the UWB anchors closest to the UWB anchors providing the TOF messages when determining the position of the mobile device.

13. The system of claim 10, wherein the controller is further configured to schedule all of the UWB anchors to perform, in the radar mode, an angle of arrival and distance determination.

14. The system of claim 10, wherein the controller is further configured to schedule only the UWB anchors for which the TOF messages are received to perform, in the radar mode, an angle of arrival and distance determination.

15. The system of claim 10, wherein the controller is further configured to schedule UWB radar sessions in the radar mode and UWB ranging sessions in the ranging mode by configuring specific ones of the UWB anchors to send radar packets without overlapping with other UWB anchors and without interfering with slots reserved for ranging.

16. The system of claim 10, wherein the one or more vehicle applications include an application for providing secure access to the vehicle.

17. The system of claim 10, wherein the controller is further configured to one or more of:
utilize unused time slots within the ranging rounds for radar sessions in the radar mode;
utilize unused ranging rounds for the radar sessions; and/or
utilize a combination of unused time slots within an existing ranging round and unused ranging rounds for the radar sessions.

18. The system of claim 10, wherein the controller is further configured to alternate between UWB radar sessions in the radar mode and UWB ranging sessions in the ranging mode in a time-synchronous manner to perform the trilateration.

19. A non-transitory computer-readable medium comprising instructions that, when executed by a controller of a vehicle having a plurality of UWB anchors, cause the controller to perform operations including to:
detect, via UWB anchors of a vehicle, TOF messages exchanged between the UWB anchors and a mobile device;
responsive to a lack of receipt of TOF messages from a quantity of the UWB anchors necessary for performing trilateration for at least a plurality of consecutive ranging rounds, switch to a radar mode to detect angle of arrival and distance information between the UWB anchors and the mobile device;
responsive to switching to the radar mode, receive CIR data from the UWB anchors;
determine a position of the mobile device based on the CIR data and the TOF messages; and
utilize the position of the mobile device for one or more vehicle application.

20. The non-transitory computer-readable medium of claim 19, further comprising instructions that, when executed by the controller, cause the controller to perform operations including to schedule all of the UWB anchors to perform, in the radar mode, an angle of arrival and distance determination.

21. The non-transitory computer-readable medium of claim 19, further comprising instructions that, when executed by the controller, cause the controller to perform operations including to schedule only the UWB anchors for which the TOF messages are received to perform, in the radar mode, an angle of arrival and distance determination.
